(19) United States
(12) Patent Application Publication
(10) Pub. No.: US 2026/0167136 A1
(43) Pub. Date: Jun. 18, 2026

(54) EXTENDED SUPPORT CONTROL METHOD AND APPARATUS

(71) Applicants: HYUNDAI MOTOR COMPANY, Seoul (KR); KIA CORPORATION, Seoul (KR)

(72) Inventors: Hoongi Lee, Hwaseong-si (KR); Hyoeun Jung, Hwaseong-si (KR); Gwangseob Kim, Hwaseong-si (KR); Chan Seok Choi, Hwaseong-si (KR)

(73) Assignees: HYUNDAI MOTOR COMPANY, Seoul (KR); KIA CORPORATION, Seoul (KR)

(21) Appl. No.: 19/391,461

(22) Filed: Nov. 17, 2025

(30) Foreign Application Priority Data
Dec. 12, 2024 (KR) 10-2024-0184335

(51) Int. Cl. B60R 16/03; B60K 35/90; H04L 67/12

(52) U.S. Cl. CPC B60R 16/03; B60K 35/90; H04L 67/12

(57) ABSTRACT

An extended support control method, performed by a vehicle, includes selecting, by a processor of a computing device, an operation mode of the computing device between a first operation mode and a second operation mode. The method further includes receiving, by the processor, a switch-on signal from a purpose-built vehicle (PBV) Interface Module (PIM), an in-vehicle infotainment (IVI), or a central communication unit (CCU). The method further includes supplying power to a specific-purposed module connected through the PIM, when the computing device operates in the first operation mode. The method further includes providing, by the processor, vehicle data to the specific-purposed module connected through the PIM by receiving a vehicle data provision request signal, when the computing device operates in the second operation mode.

### CROSS-REFERENCE TO RELATED APPLICATION

This application claims the priority to and the benefit of Korean Patent Application No. 10-2024-0184335 filed with the Korean Intellectual Property Office on Dec. 12, 2024, the entire contents of which are incorporated herein by reference.

### TECHNICAL FIELD

The present disclosure relates to an extended support control method and an extended support apparatus, and more specifically, the present disclosure relates to an extended support control method and an extended support apparatus capable of supporting the extensibility of providing power and data of a vehicle to the outside.

### BACKGROUND

The current automobile industry is rapidly developing with a focus on the development of purpose-built vehicles (PBVs), and based on this, the demand for customized and conversion-specific solutions suitable for various special-purpose vehicles is increasing. Existing special-purpose vehicles are focused on fixed purposes and have limitations in meeting the diverse needs of users. Accordingly, customized electronic components for developing new purpose-based specialized vehicles and the technological requirements for controlling them are becoming increasingly important. Specifically, a user may need technology that allows the user to control on and off of the power supply of customized or additionally installed electronic components via an application, an in-vehicle infotainment (IVI) system, or an upfit switch. Additionally, the importance of vehicle data is increasingly being emphasized in the process of customizing special-purpose vehicles. In order to transfer the vehicle data required for customization work to the outside, a technical solution that effectively connects internal vehicle data with external devices is also required. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure aims to provide an extended support control method and an extended support control apparatus capable of supporting the extensibility of providing power and data of a vehicle to the outside.

An extended support control method, performed by a vehicle, may include selecting, by a processor of a computing device, an operation mode of the computing device between a first operation mode and a second operation mode. The method may further include receiving, by the processor, a switch-on signal from a purpose-built vehicle (PBV) Interface Module (PIM), an in-vehicle infotainment (IVI), or a central communication unit (CCU). The method may further include supplying power to a specific-purposed module connected through the PIM, when the computing device operates in the first operation mode. The method may further include providing, by the processor, vehicle data to the specific-purposed module connected through the PIM by receiving a vehicle data provision request signal, when the computing device operates in the second operation mode.

Supplying power to the specific-purposed module may include checking, by the processor, a predetermined first condition, in response to the switch-on signal; transmitting, by the processor, a load power-on command to the PIM; and supplying power to the specific-purposed module, when it is confirmed that the predetermined first condition is satisfied.

Checking the predetermined first condition may include checking, by the processor, whether the vehicle is in a drivable mode or a utility mode; checking, by the processor, whether the vehicle is in a P range, when a stop condition is set in the IVI; and checking, by the processor, whether a state of the PIM is normal.

The method may further include checking, by the processor, a predetermined second condition; and transmitting, by the processor, a load power-off command to the PIM and blocking the power supplied to the specific-purposed module connected through the PIM, when it is confirmed that the predetermined second condition is satisfied.

Checking the predetermined second condition may include checking, by the processor, whether a switch-off signal is received from the PIM, the IVI or the CCU; checking, by the processor, whether the vehicle is not in a drivable mode and a utility mode; checking, by the processor, whether the vehicle is not in a P range, when a stop condition is set in the IVI; or checking, by the processor, whether a state of the PIM is not normal.

The PIM may include a plurality of terminals, and one terminal among the plurality of terminals may be connected to a physical switch mounted in the vehicle.

The one terminal may be connected to both of the physical switch and the IVI; and remaining terminals among the plurality of terminals may be only connected to the IVI.

The method may further include displaying, by the processor, a user interface that enables a user terminal connected through the IVI or the CCU to perform button setting and at least one of output terminal setting or stop condition setting of the PIM associated with the button setting on a screen.

Providing the vehicle data to the specific-purposed module may include converting, by the processor, a controller area network (CAN) communication data into a signal of another format, in response to the vehicle data provision request signal; and providing, by the processor, the signal to the specific-purposed module.

The PIM may include a plurality of terminals. The method may further include outputting, by at least one terminal of the plurality of terminals, a pulse-width modulation (PWM) signal converted from the CAN communication data.

The method may further include analyzing, by the specific-purposed module, the PWM signal by using a predetermined vehicle data-PWM signal map.

The vehicle data provided as the PWM signal may include data regarding at least one of a battery voltage, a battery state-of-charge, or a vehicle speed.

The method may further include outputting, by remaining terminals among the plurality of terminals, a low-side output (LSO) signal converted from the CAN communication data.

The method may further include analyzing, by the specific-purposed module, a predetermined LSO signal by using the vehicle data-LSO signal map.

The vehicle data provided as the LSO signal may include data regarding at least one of whether a door is closed, power on/off status, electronic parking brake (EPB) status, whether a door is opened, or a gear position.

An extended support control apparatus may include at least one non-transitory computer-readable media configured to store an instruction. The apparatus may further include at least one processor. The at least one processor may be configured, by executing the instruction, to select an operation mode of the at least one processor between a first operation mode and a second operation mode. The at least one processor may be further configured to receive a switch-on signal from a purpose-built vehicle (PBV) Interface Module (PIM), an in-vehicle infotainment (IVI), or a central communication unit (CCU). The at least one processor may be further configured to supply power to a specific-purposed module connected through the PIM, when the at least one processor operates in the first operation mode. The at least one processor may be further configured to receive a vehicle data provision request signal and provide the vehicle data to the specific-purposed module connected through the PIM, when the at least one processor operates in the second operation mode.

The at least one processor may be further configured to check a predetermined first condition in response to the switch-on signal; and transmit a load power-on command to the PIM and supply power to the specific-purposed module, when it is confirmed that the predetermined first condition is satisfied.

The at least one processor may be further configured to check a predetermined second condition; and transmit a load power-off command to the PIM and block the power supplied to the specific-purposed module connected through the PIM, when it is confirmed that the predetermined second condition is satisfied.

The at least one processor may be further configured to convert a controller area network (CAN) communication data into a signal of another format, in response to the vehicle data provision request signal; and provide the signal to the specific-purposed module.

A non-transitory computer-readable media may store an instruction executable by a processor of a computing device. The processor may be configured to select an operation mode of the computing device between a first operation mode and a second operation mode. The processor may be configured to receive a switch-on signal from a purpose-built vehicle (PBV) Interface Module (PIM), an in-vehicle infotainment (IVI) or a central communication unit (CCU). The processor may be configured to supply power to a specific-purposed module connected through the PIM, when the processor operates in the first operation mode. The processor may be configured to receive a vehicle data provision request signal and provide the vehicle data to the specific-purposed module connected through the PIM, when the processor operates in the second operation mode.

### BRIEF DESCRIPTION OF THE DRAWINGS

FIG. 1 is a drawing for explaining an extended support control apparatus according to an embodiment.

FIG. 2 is a drawing for explaining an extended support control apparatus according to an embodiment.

FIG. 3 is a drawing for explaining an extended support control method according to an embodiment.

FIG. 4 and FIGS. 5A-FIG. 5H are drawings for explaining an extended support control apparatus according to an embodiment.

FIG. 6 is a drawing for explaining an extended support control apparatus according to an embodiment.

FIG. 7 is a drawing for explaining an extended support control apparatus according to an embodiment.

FIG. 8 is a drawing for explaining implementation example of an extended support control apparatus and an extended support control method according to an embodiment.

FIG. 9 is a drawing for explaining a computing device according to an embodiment.

### DETAILED DESCRIPTION

The present disclosure is described more fully hereinafter with reference to the accompanying drawings, in which embodiments of the present disclosure are shown. As those having ordinary skill in the art should realize, the described embodiments may be modified in various different ways, all without departing from the spirit or scope of the present disclosure. Accordingly, the drawings and description should be regarded as illustrative in nature and not restrictive. Like reference numerals designate like elements throughout the specification.

Throughout the present disclosure, when a part “includes” a certain element, it means that other elements may be further included, rather than excluding other elements, unless otherwise stated. Terms including ordinal numbers, such as first, second, and the like, are used only to describe various constituent elements and should not be interpreted as limiting these constituent elements. The terms are only used to differentiate one constituent element from other constituent elements.

In addition, terms such as “ . . . part,” “ . . . portion,” “ . . . er/or,” or “module” disclosed in the present specification may mean a unit that may process at least one function or operation described in the present disclosure, and this may be implemented by hardware, software, or a combination thereof. Additionally, at least some of the configurations or functions of an extended support control method and apparatus according to the embodiments described below may be implemented as a program or software, and the program or software may be stored in a computer-readable medium. When a controller, part, portion, “ . . . er/or,” module, component, device, element, or the like of the present disclosure is described as having a purpose or performing an operation, function, or the like, the controller, part, portion, “ . . . er/or,” module, component, device, element, or the like should be considered herein as being “configured to” meet that purpose or to perform that operation or function. Each controller, part, portion, “ . . . er/or,” module, component, device, element, and the like may separately embody or be included with a processor and a memory, such as a non-transitory computer readable media, as part of the apparatus.

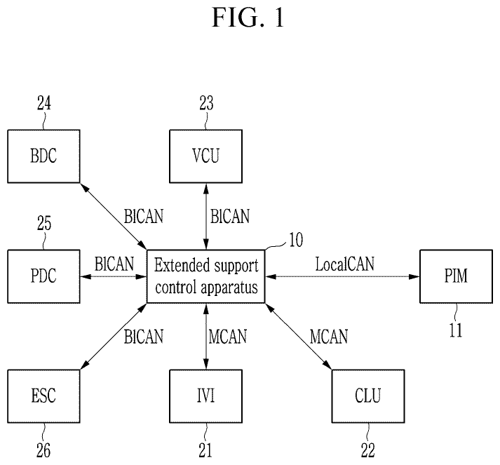

FIG. 1 is a drawing for explaining an extended support control apparatus according to an embodiment.

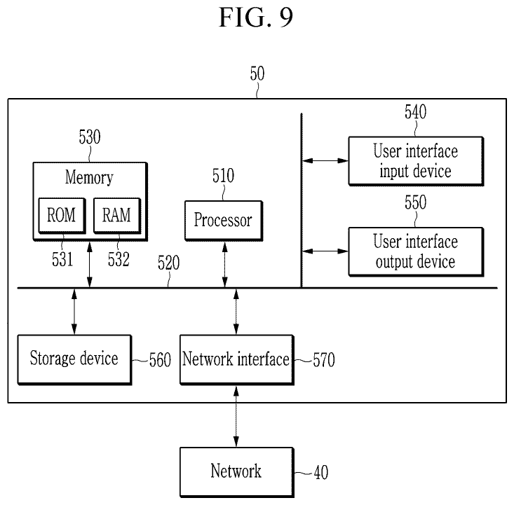

Referring to FIG. 1, an extended support control apparatus according to an embodiment 10 may be implemented as a computing device including a processor and memory. For example, a connection device for the vehicle and an external device may be implemented as a computing device 50, as described later in connection with FIG. 9. The computing device 50 may be implemented in a vehicle 1, for example, implemented as a controller mounted on the vehicle 1. In this case, one or more processors may correspond to a processor 510 of the computing device 50, and one or more memory devices may correspond to a memory 520 of the computing device 50. Alternatively, in some embodiments, an extended support control apparatus 10 may include one or more non-transitory computer-readable media including an instruction and one or more processors configured to perform an operation by executing the instruction. The operation may include configurations, functions, steps, or the like described in this specification with respect to an extended support control method and apparatus according to embodiments.

The extended support control apparatus 10 may be implemented within the vehicle 1. The extended support control apparatus 10 may exchange data with other controllers implemented together within the vehicle 1, for example, at least one of a purpose-built vehicle (PBV) Interface Module (PIM) 11, an in-vehicle infotainment (IVI) 21, a cluster (CLU) 22, a vehicle control unit (VCU) 23, a body domain controller (BDC) 24, a power-net domain controller (PDC) 25, an electronic stability control (ESC) 26, a central communication unit (CCU) 27, and a domain control unit (DCU) 28 through an internal network. In some embodiments, internal network may include a controller area network (CAN), a local interconnect network (LIN), and an automotive ethernet, or the like.

In some embodiments, the extended support control apparatus 10 may be connected to the IVI 21 and the CLU 22 through a MCAN (i.e., main CAN), and may be connected to the BDC 24, the PDC 25, and the ESC 26 through a B1CAN (i.e., body CAN). The extended support control apparatus 10 may be connected to the PIM 11 through a LocalCAN. The MCAN is a major CAN bus of the vehicle, which may be a bus that processes high priority data and has a fast communication speed, and through which data closely related to the stability and driving performance of the vehicle is transmitted. The B1CAN may be used for data communication related to the vehicle's body control and may be a bus through which data related to user convenience or auxiliary systems are transmitted. The LocalCAN may be a CAN network that is limitedly used within a specific system or local area within a vehicle, and the LocalCAN can be used to handle communication between limited sensors and actuators, or to communicate with specific subsystems.

The extended support control apparatus 10 may be a computing device implemented in a vehicle designed as a purpose-built vehicle (PBV) by being connected to a specific-purposed module through the PIM 11. The extended support control apparatus 10 may operate in a first operation mode and a second operation mode. When operating in the first operation mode as the first operation mode is selected, the extended support control apparatus 10 may receive a switch-on signal from the PIM 11, the IVI 21, or the CCU 27, to supply power to the specific-purposed module connected through the PIM 11. When operating in the second operation mode as the second operation mode is selected, the extended support control apparatus 10 may receive a vehicle data provision request signal, to provide vehicle data to the specific-purposed module connected through the PIM 11.

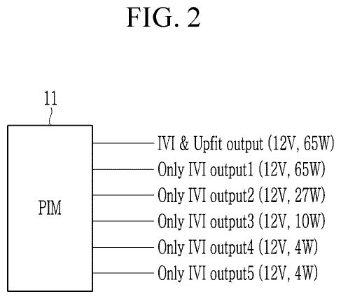

FIG. 2 is a drawing for explaining an extended support control apparatus according to an embodiment.

Referring to FIG. 2, the PIM 11 may include a plurality of terminals. One terminal among the plurality of terminals may be connected to both of an upfit switch, i.e., a physical switch, and the IVI 21, and remaining terminals among the plurality of terminals may be connected only to the IVI 21.

For example, as shown in the drawings, the PIM 11 may include a first terminal corresponding to IVI & Upfit output (12V, 65 W), a second terminal corresponding to IVI output (12V, 65 W), a third terminal corresponding to IVI output (12V, 27 W), a fourth terminal corresponding to IVI output (12V, 10 W), a fifth terminal corresponding to IVI output (12V, 4 W), and a sixth terminal corresponding to IVI output (12V, 4 W). The first terminal may be connected to the IVI 21 and the upfit switch, and the second terminal to the sixth terminal may be connected only to the IVI 21. In other words, the first terminal may not only communicate with the IVI 21, but also exchange signals with the upfit switch physically implemented in the vehicle.

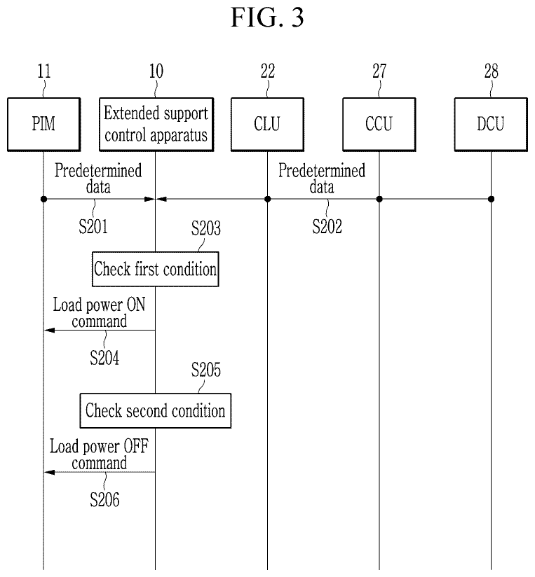

FIG. 3 is a drawing for explaining an extended support control method according to an embodiment.

Referring to FIG. 3, an extended support control method according to an embodiment may include steps S201 and S202 of receiving, by the extended support control apparatus 10, a predetermined data from the PIM 11, the CLU 22, the CCU 27, and the DCU 28. The predetermined data may include a signal (e.g., the switch-on signal) representing that the user manipulation or the user input has occurred through the upfit switch, the IVI 21, and the application of the user terminal, or the like.

At step S203, the extended support control apparatus 10 may check a predetermined first condition in response to the switch-on signal. When it is confirmed that the first condition is satisfied, at step S204, the extended support control apparatus 10 may transmit a load power-on command to the PIM 11, to supply power to the specific-purposed module connected to the vehicle through the PIM 11.

In some embodiments, the extended support control apparatus 10 may check whether the vehicle is in a drivable mode (e.g., EV Ready) or a utility mode, in order to check the first condition. When a stop condition is set in the IVI 21, the extended support control apparatus 10 may check whether the vehicle is in the P range and may check whether a state of the PIM 11 is normal. When the above conditions are all satisfied, the extended support control apparatus 10 may transmit the load power-on command to the PIM 11, to supply power to the specific-purposed module connected to the vehicle through the PIM 11.

At step S205, the extended support control apparatus 10 may check a predetermined second condition. When it is confirmed that the first condition is satisfied, at step S206, the extended support control apparatus 10 may transmit a load power-off command to the PIM 11, to block the power supplied to the specific-purposed module connected to the vehicle through the PIM 11.

In some embodiments, the extended support control apparatus 10 may check whether a switch-off signal is received from the PIM 11, the IVI 21 or the CCU 27, in order to check the second condition, and may check whether the vehicle is not in the drivable mode (e.g., EV Ready) and the utility mode. When the stop condition is set in the IVI 21, the extended support control apparatus 10 may check whether the vehicle is not in the P range and may check whether the state of the PIM 11 is not normal. When at least one of the above conditions is satisfied, the extended support control apparatus 10 may transmit the load power-off command to the PIM 11, to block the power supplied to the specific-purposed module connected to the vehicle through the PIM 11.

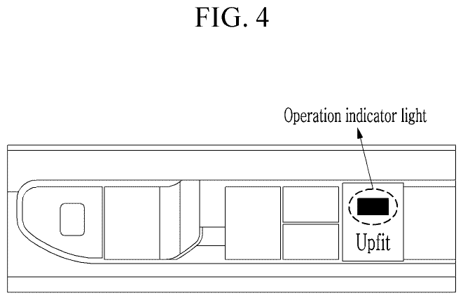

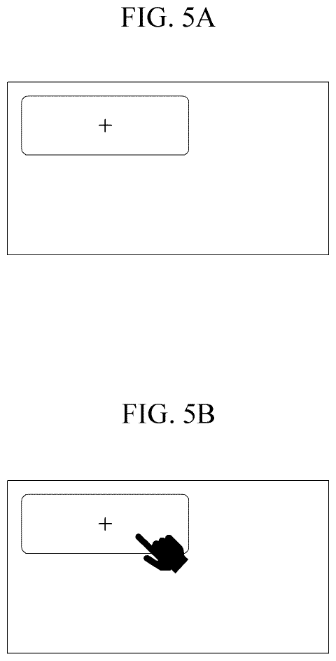

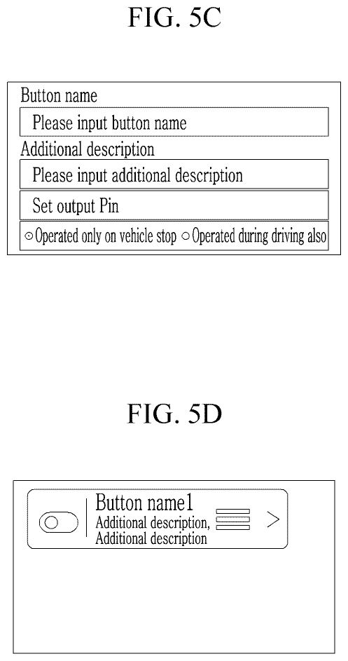

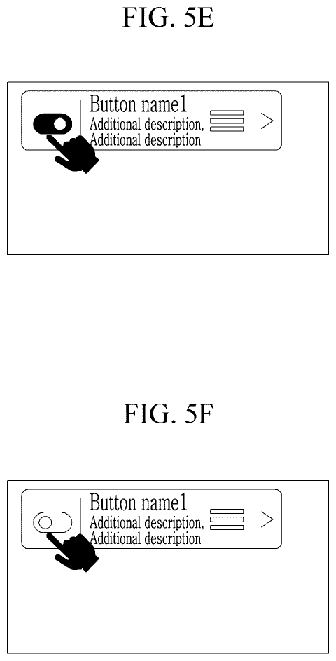

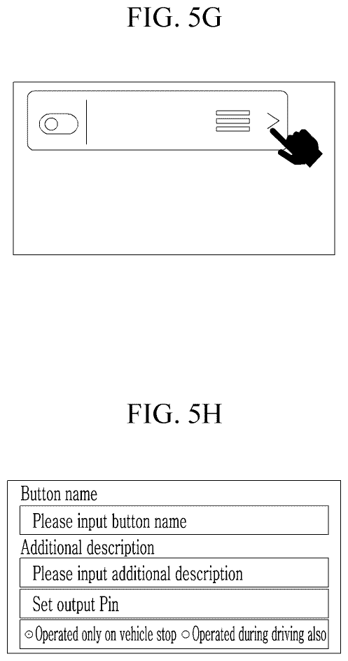

FIG. 4 and FIG. 5A-FIG. 5H are drawings for explaining an extended support control apparatus according to an embodiment.

Referring to FIG. 4, as an implementation example of an extended support control apparatus according to an embodiment, it is illustrated that the upfit switch is implemented as a physical switch. One of the plurality of terminals of the PIM 11 may be connected to a physical switch mounted on the vehicle. Depending on how the user manipulates the physical switch, the extended support control apparatus 10 may supply power to the specific-purposed module connected to the vehicle through the PIM 11 or may block the power supplied to the specific-purposed module connected to the vehicle through the PIM 11.

In some embodiments, the upfit switch may be equipped with an operation indicator lamp. The operation indicator lamp may visually represent whether the power is supplied to the user. In some embodiments, the indicator output of the upfit switch may be implemented to have pulse-width modulation (PWM) frequency of 125 Hz, and duty ratio of 100 % in the detent state, and in the range of 3 %-33.33 % when not in the detent state, to reflect a setting value of indicator brightness of the cluster in 90 steps.

Referring to FIG. 5A-FIG. 5H, as an implementation example of an extended support control apparatus according to an embodiment, a screen of the user terminal connected through the IVI 21 or the CCU 27 is illustrated. The extended support control apparatus 10 may display a user interface that enables the user terminal connected through the IVI 21 or the CCU 27 to perform button setting and at least one of output terminal setting or stop condition setting of the PIM 11 associated with the button setting on the screen.

For example, as shown in the screens of FIG. A-FIG. 5H of the IVI 21 or the user terminal, a user interface for information input and setting, such as a button name, an additional description regarding the button, an output pin, setting on whether to operate only on when stopped or to operate during driving, or the like, may be displayed. In addition, the IVI 21 or the screen of the user terminal may display a toggle switch implemented to switch between on and off, so as to provide a function that allows the user to easily control power supply and cutoff.

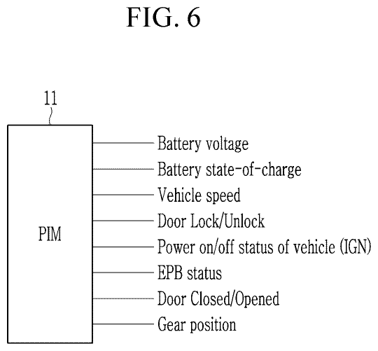

FIG. 6 is a drawing for explaining an extended support control apparatus according to an embodiment.

Referring to FIG. 6, the PIM 11 may include the plurality of terminals. For example, as shown in the drawings, the PIM 11 may include a plurality of terminals corresponding to signals regarding a battery voltage, a battery state-of-charge, a vehicle speed, a door closed state, a power on/off status, an electronic parking brake (EPB) status, a door open state, and a gear position.

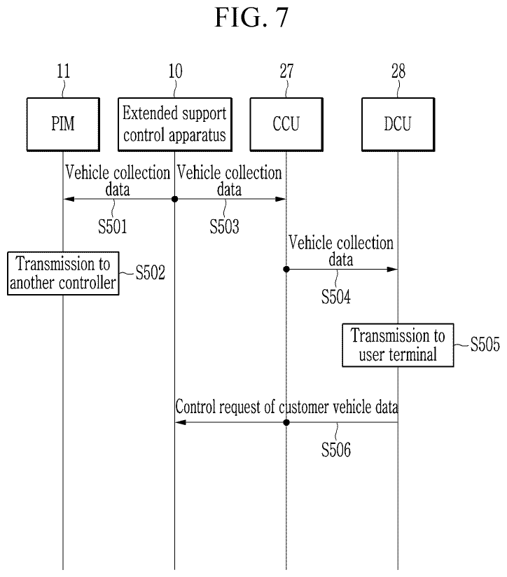

FIG. 7 is a drawing for explaining an extended support control apparatus according to an embodiment.

Referring to FIG. 7, an extended support control method according to an embodiment may include, a step S501 of converting, by the extended support control apparatus 10, a CAN communication data into a signal of another format and transmitting the converted vehicle collection data to the PIM 11. The extended support control method may further include a step S502 of providing, by the PIM 11, the converted signal to another controller such as the specific-purposed module, for example, in response to the vehicle data provision request signal generated by the specific-purposed module. In the case of the step S501 and the step S502, the converting the CAN communication data into a signal of another format may be performed on the side of the PIM 11, depending on implementation purpose and environment.

The method may perform, a step S503 of converting, by the extended support control apparatus 10, the CAN communication data into a signal of another format and transmitting the converted vehicle collection data to the CCU 27. The extended support control method may further include a step S504 of transmitting, by the CCU 27, the converted vehicle collection data to the DCU 28. The extended support control method may further include a step S505 of transmitting, by the DCU 28, the converted vehicle collection data to the user terminal.

In some embodiments, for example, when a control request of the customer vehicle data is received to the extended support control apparatus 10 from the specific-purposed module at step S506, the provision of such vehicle collection data as described above may be performed as that request is triggered.

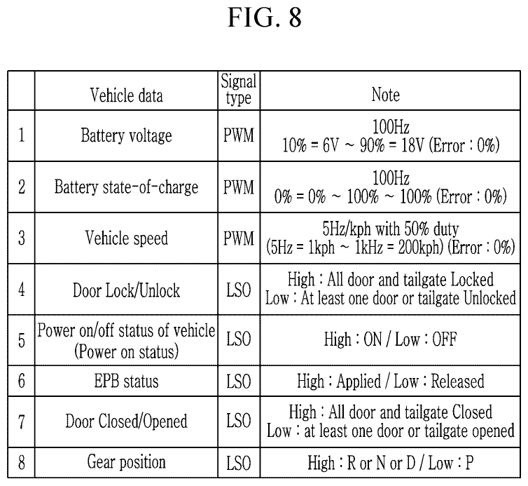

FIG. 8 is a drawing for explaining implementation example of an extended support control apparatus and method according to an embodiment.

Referring to FIG. 8, at least one terminal of the plurality of terminals may output a PWM signal converted from the CAN communication data. Remaining terminals among the plurality of terminals may output a low-side output (LSO) signal converted from the CAN communication data. For example, as shown in the drawings, the battery voltage, the battery state-of-charge, and the vehicle speed may be converted into PWM signals and output, and the door closed state, the power on/off status, the EPB status, the door open state, and the gear position may be converted into LSO signals and output.

In the case of the PWM signal, the specific-purposed module may analyze the PWM signal by using the vehicle data-PWM signal map prepared in advance. In other words, because the interpretation criteria for the PWM signal transmitted from the extended support control apparatus 10 through the PIM 11 are shared in advance with the specific-purposed module, the meaning may be interpreted from the waveform of the PWM signal.

In the case of the LSO signal, the specific-purposed module may analyze the LSO signal by using the vehicle data-LSO signal map prepared in advance. In other words, because the interpretation criteria for the LSO signal transmitted from the extended support control apparatus 10 through the PIM 11 are shared in advance with the specific-purposed module, the meaning may be interpreted from the waveform of the LSO signal.

FIG. 9 is a drawing for explaining a computing device according to an embodiment.

Referring to FIG. 9, an extended support control method and apparatus according to the embodiments may be implemented using a computing device 50. The computing device 50 may be implemented as various types of electronic devices, servers or similar devices, and its function may be implemented through a combination of software and hardware.

The computing device 500 may include at least one of a processor 510, a memory 530, a user interface input device 540, a user interface output device 550, or a storage device 560 that communicate with each other through a bus 520. The computing device 50 may include a network interface 570 electrically connected to a network 40. The network interface 570 may send or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may be configured to implement the various functions and methods described above with reference to FIGS. 1-8.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means, for example, a peripheral component interconnect express (PCIe) interface for high-speed data transmission or a memory controller.

In some embodiments, at least some of the components or functions of an extended support control method and apparatus according to the embodiments may be implemented as a program or software executed on the computing device 50, and the program or software may be stored on a computer-readable recording medium or storage medium. Specifically, according to an embodiment, a computer-readable recording medium or storage medium may record a program for executing steps included in an implementation of an extended support control method and an extended support control apparatus according to embodiments, on a computer including the processor 510 executing a program or instructions stored in the memory 530 or the storage device 560.

In some embodiments, at least some configuration or function of an extended support control method and an extended support control apparatus according to embodiments may be implemented by using hardware or circuitry of the computing device 50 or may also be implemented by using separate hardware or circuitry that may be electrically connected to the computing device 50.

In some embodiments, one or more non-transitory computer-readable media including an instruction executable by the computing device 50 may be provided, and the instruction may cause the computing device 50 to perform the operation, when executed by one or more processors of the computing device 50. The operation may include configurations, functions, steps, or the like described in this specification in connection with extended support control method and apparatus according to embodiments.

According to an embodiment, the supply of power to an electronic device customized or additionally mounted in a new purpose-based specialized vehicle environment and the external connection of the vehicle data may be effectively implemented.

While the present disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. An extended support control method of a vehicle, the extended support control method comprising:
selecting, by a processor of a computing device, an operation mode of the computing device between a first operation mode and a second operation mode;
receiving, by the processor, a switch-on signal from a purpose-built vehicle (PBV) Interface Module (PIM), an in-vehicle infotainment (IVI), or a central communication unit (CCU);
supplying power to a specific-purposed module connected through the PIM, when the computing device operates in the first operation mode; and
providing, by the processor, vehicle data to the specific-purposed module connected through the PIM by receiving a vehicle data provision request signal, when the computing device operates in the second operation mode.

2. The extended support control method of claim 1, wherein supplying power to the specific-purposed module comprises:
checking, by the processor, a predetermined first condition, in response to the switch-on signal; and
transmitting, by the processor, a load power-on command to the PIM and supplying power to the specific-purposed module, when it is confirmed that the predetermined first condition is satisfied.

3. The extended support control method of claim 2, wherein checking the predetermined first condition comprises:
checking, by the processor, whether the vehicle is in a drivable mode or a utility mode;
checking, by the processor, whether the vehicle is in a P range, when a stop condition is set in the IVI; and
checking, by the processor, whether a state of the PIM is normal.

4. The extended support control method of claim 2, further comprising:
checking, by the processor, a predetermined second condition; and
transmitting, by the processor, a load power-off command to the PIM and blocking the power supplied to the specific-purposed module connected through the PIM, when it is confirmed that the predetermined second condition is satisfied.

5. The extended support control method of claim 4, wherein checking the predetermined second condition comprises:
checking, by the processor, whether a switch-off signal is received from the PIM, the IVI or the CCU;
checking, by the processor, whether the vehicle is not in a drivable mode and a utility mode;
checking, by the processor, whether the vehicle is not in a P range, when a stop condition is set in the IVI; or
checking, by the processor, whether a state of the PIM is not normal.

6. The extended support control method of claim 2, wherein:
the PIM comprises a plurality of terminals; and
one terminal among the plurality of terminals is connected to a physical switch mounted in the vehicle.

7. The extended support control method of claim 6, wherein:
the one terminal is connected to both of the physical switch and the IVI; and
remaining terminals among the plurality of terminals are only connected to the IVI.

8. The extended support control method of claim 7, further comprising:
displaying, by the processor, a user interface that enables a user terminal connected through the IVI or the CCU to perform button setting and at least one of output terminal setting or stop condition setting of the PIM associated with the button setting on a screen.

9. The extended support control method of claim 1, wherein providing the vehicle data to the specific-purposed module comprises:
converting, by the processor, a controller area network (CAN) communication data into a signal of another format, in response to the vehicle data provision request signal; and
providing, by the processor, the signal to the specific-purposed module.

10. The extended support control method of claim 9, wherein:
the PIM comprises a plurality of terminals, and
the method further comprises outputting, by at least one terminal of the plurality of terminals, a pulse-width modulation (PWM) signal converted from the CAN communication data.

11. The extended support control method of claim 10, further comprising:
analyzing, by the specific-purposed module, the PWM signal by using a predetermined vehicle data-PWM signal map.

12. The extended support control method of claim 10, wherein the vehicle data provided as the PWM signal comprises data regarding at least one of a battery voltage, a battery state-of-charge, or a vehicle speed.

13. The extended support control method of claim 10, further comprising:
outputting, by remaining terminals among the plurality of terminals, a low-side output (LSO) signal converted from the CAN communication data.

14. The extended support control method of claim 13, further comprising:
analyzing, by the specific-purposed module, the LSO signal by using a predetermined vehicle data-LSO signal map.

15. The extended support control method of claim 13, wherein the vehicle data provided as the LSO signal comprises data regarding at least one of whether a door is closed, power on/off status, electronic parking brake (EPB) status, whether a door is opened, or a gear position.

16. An extended support control apparatus comprising:
at least one non-transitory computer-readable media configured to store an instruction; and
at least one processor configured, by executing the instruction, to:
select an operation mode of the at least one processor between a first operation mode and a second operation mode;
receive a switch-on signal from a purpose-built vehicle (PBV) Interface Module (PIM), an in-vehicle infotainment (IVI), or a central communication unit (CCU);
supply power to a specific-purposed module connected through the PIM, when the at least one processor operates in the first operation mode; and
receive a vehicle data provision request signal and provide vehicle data to the specific-purposed module connected through the PIM, when the at least one processor operates in the second operation mode.

17. The extended support control apparatus of claim 16, wherein the at least one processor is further configured to:
check a predetermined first condition in response to the switch-on signal; and
transmit a load power-on command to the PIM and supply, by the at least one processor, power to the specific-purposed module, when it is confirmed that the predetermined first condition is satisfied.

18. The extended support control apparatus of claim 17, the at least one processor is further configured to:
check a predetermined second condition;
transmit a load power-off command to the PIM and block the power supplied to the specific-purposed module connected through the PIM, when it is confirmed that the predetermined second condition is satisfied.

19. The extended support control apparatus of claim 16, wherein the at least one processor is further configured to:
convert a controller area network (CAN) communication data into a signal of another format, in response to the vehicle data provision request signal; and
provide the signal to the specific-purposed module.

20. A non-transitory computer-readable media configured to store an instruction executable by a processor of a computer device, the processor configured to:
select an operation mode of the computing device between a first operation mode and a second operation mode;
receive a switch-on signal from a purpose-built vehicle (PBV) Interface Module (PIM), an in-vehicle infotainment (IVI) or a central communication unit (CCU);
supply power to a specific-purposed module connected through the PIM, when the processor operates in the first operation mode; and
receive a vehicle data provision request signal and provide vehicle data to the specific-purposed module connected through the PIM, when the processor operates in the second operation mode.
